(19) United States
(12) Patent Application Publication
(10) Pub. No.: US 2020/0104912 A1
(43) Pub. Date: Apr. 2, 2020

(54) SYSTEMS AND METHODS FOR REAL-TIME ALLOCATION OF RESOURCES

(71) Applicant: The Toronto-Dominion Bank, Toronto (CA)

(72) Inventors: Avinash MALLIAH, Toronto (CA); Gregory BODDISON, Toronto (CA); Angelique Louise CARLE, Sutton West (CA); Kyle Michael Richard MCLEAN, Toronto (CA); Arun Victor JAGGA, Toronto (CA)

(73) Assignee: The Toronto-Dominion Bank, Toronto (CA)

(21) Appl. No.: 16/149,460

(22) Filed: Oct. 2, 2018

(51) Int. Cl. G06Q 40/02; G06F 17/30; G06Q 50/16

(52) U.S. Cl. CPC G06Q 40/025; G06Q 50/167; G06F 17/30241

(57) ABSTRACT

A method for processing a resource request is disclosed. The method includes: receiving a first resource request including a quantity of a first resource that is requested, an identity of a requester, and first asset data for a first asset; accessing a first database to identify two or more second assets different from the first asset based on determining that location information associated with the second assets satisfies at least one predetermined condition relating to the location information associated with the first asset; retrieving second asset data for the second assets; transmitting a second request to an asset valuation database to obtain real-time asset value data for the first asset based on the retrieved second asset data; receiving the asset value data for the first asset; generating approval data indicating whether the first resource request is approved; and transmitting the approval data to the first client device.

### TECHNICAL FIELD

The present application relates to resource allocation and, in particular, to systems and methods for allocating a finite resource to nodes of a network. Systems and methods described herein may be suitable for use by a resource management entity in processing resource requests and allocating resources, in real-time, to one or more requesting parties.

### BACKGROUND

Computing or system resources, such as processing power, memory, and bandwidth, may be shared among multiple nodes of a network. By way of example, in a parallel computing system, a plurality of processors may have access to a shared memory to exchange information between the processors. Shared computing resources are typically finite. An inefficient allocation of resources may result in waste (e.g. longer completion times for parallel tasks) and/or deficiency of resources at one or more network nodes.

When a finite computing resource is available to be shared between nodes of a network, nodes that have a surplus quantity of the resource may “lend” out part or all of the surplus to other nodes. That is, if a certain node has access to or possesses a quantity of the computing resource that is greater than that which it needs or is currently utilizing, said node may temporarily lend the surplus quantity to a different node of the network. More generally, a first network node may have capacity to temporarily grant a specific quantity of a computing resource to a second network node. For example, a node (e.g. root node) representing a network resource management entity may determine a resource allocation scheme for lending available computing resources to one or more other nodes. The “borrower” node may utilize the loaned quantity of the resource, and eventually either return it back to the lender node or share part or all of the loaned quantity with yet another node. The borrower may, for example, return the loaned quantity of the resource upon occurrence of a predetermined condition (e.g. upon direct request by the lender node, elapse of predefined period of time, etc.).

While resources may be finite at any given moment, the pool of available resources for a network may expand or contract over time, or the nodes which share such resources may change. For example, new memory or processing capacity may be added to a system, or a particular node may be added to or removed from the network. Any lags in information regarding the changes to the available resources and/or network composition may lead to inefficiencies in allocation. More broadly, in the context of real-time allocation of resources, information lags and insufficient data may cause the available resources to be allocated in a non-optimal manner.

Thus, it would be desirable to provide improved methods and systems for allocating resources in networked environments.

### BRIEF DESCRIPTION OF DRAWINGS

Reference will now be made, by way of example, to the accompanying drawings which show example embodiments of the present application and in which:

FIG. 1 is a schematic diagram illustrating an operating environment of an example embodiment;

FIG. 2 is a high-level operation diagram of an example computing system for implementing example embodiments of a resource allocation platform;

FIG. 3 depicts a simplified software organization of the example computing system of FIG. 2;

FIG. 4 shows, in flowchart form, an example method for processing a resource request;

FIG. 5 shows, in flowchart form, an example method for adjudicating a resource request; and

FIG. 6 shows, in flowchart form, an example method for requesting asset value data for an asset.

Like reference numerals are used in the drawings to denote like elements and features.

### DETAILED DESCRIPTION OF EXAMPLE EMBODIMENTS

In one aspect, the present disclosure describes a computing device. The computing device includes a processor, a communications module coupled to the processor, and a computer-readable storage medium coupled to the processor. The computer-readable storage medium contains instructions that are configured to cause the processor to: receive from a first client device via the communications module a first resource request including a quantity of a first resource that is requested, an identity of a requester, and first asset data for a first asset, the first asset data including location information associated with the first asset; access a first database to identify two or more second assets different from the first asset based on determining that location information associated with each of the two or more second assets satisfies at least one predetermined condition relating to the location information associated with the first asset; retrieve, from the first database, second asset data for the two or more second assets; transmit a second request to an asset valuation database via the communications module, the second request to obtain real-time asset value data for the first asset based on the retrieved second asset data; receive, from the asset valuation database, the asset value data for the first asset; generate approval data indicating whether the first resource request is approved, the approval data being generated based on the first resource request and the received asset value data for the first asset; and transmit the approval data to the first client device.

In another aspect, the present disclosure describes a method of processing a resource request. The method includes: receiving from a first client device via the communications module a first resource request including a quantity of a first resource that is requested, an identity of a requester, and first asset data for a first asset, the first asset data including location information associated with the first asset; accessing a first database to identify two or more second assets different from the first asset based on determining that location information associated with each of the two or more second assets satisfies at least one predetermined condition relating to the location information associated with the first asset; retrieving, from the first database, second asset data for the two or more second assets; transmitting a second request to an asset valuation database via the communications module, the second request to obtain real-time asset value data for the first asset based on the retrieved second asset data; receiving, from the asset valuation database, the asset value data for the first asset; generating approval data indicating whether the first resource request is approved, the approval data being generated based on the first resource request and the received asset value data for the first asset; and transmitting the approval data to the first client device.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, the term “resource” may cover various different types of shareable resources, such as computing resources (e.g. network bandwidth, processing power, and memory), data, tokens, or tradeable objects. A resource may be shared or transferred between nodes of a network; for example, a node (“lender node”) may temporarily lend a fixed quantity of a resource to a borrower node for its consumption or use. A lender node may directly transfer a quantity of a resource to the borrower node or, alternatively, grant, to the borrower node, access to an available quantity of the resource.

A “resource request” may refer to a request, by a borrower, to a lending entity to obtain a specific quantity of a resource. A borrower may, for example, initiate a resource request to temporarily acquire a fixed quantity of a desired resource. A resource request originating from a node of a network may be initiated by an owner or user of a computing system that is associated with the node. For example, a user of a computing device may initiate a resource request via a user interface provided on a display of the computing device. Alternatively, a resource request may be automatically initiated at a network node in response to detection of a predefined trigger or in response to a predetermined condition being satisfied. For example, if a low level/quantity of a computing resource is detected at a node, the node may automatically generate a resource request to obtain more of the computing resource from another node. A resource request may be transmitted to a node associated with a lending entity which may, by itself or through a third party, evaluate the request and decide whether to approve or reject the request.

In an aspect, the present application discloses a system for managing resource allocation. More specifically, an automated system for processing and adjudicating resource requests is disclosed. The system of the present disclosure is designed to enable real-time disposition of resource requests based on dynamic valuation of assets which inform the decision of whether to approve the resource requests. In accordance with embodiments of the present disclosure, a perceived value or metric associated with a first asset that is identified in a resource request may be obtained, via a query engine that accesses various databases containing dynamically updated values/metrics for one or more known assets related to the first asset. In particular, a perceived value/metric for the first asset is determined based, at least in part, on estimates of values/metrics associated with those assets which satisfy certain predetermined criteria relating to the first asset. The perceived value/metric for the first asset thus obtained may then be provided as an input to a resource request adjudication module, which applies the inputs to a suitable model for deriving resource allocation approval data. The resource allocation approval data may then be communicated to the requester and/or a resource controller entity managing access to the requested resource.

In a further aspect, the present disclosure describes techniques by which authorization for use and/or allocation of resources may be granted. The decision to grant such authorization is based on a real-time assessment of resource requests, where the assessment is informed by context-driven valuation of requesters' assets. A request for authorization is processed by an automated system for evaluating resource requests. The system may be configured to access, update, and cross-reference databases containing asset value/metric data to obtain perceived asset values/metrics which inform the decision of whether to grant authorization to access resources issued by a lending entity. If the request is approved, an express authorization to access the resource in the approved quantity may be generated and transmitted to the requester.

In a further aspect, the present disclosure describes a system for issuing resources in real-time to applicants. The system may include a resource request evaluation engine, designed to handle requests for instant issuance of resources and/or authorization of resource transfers. The issuing/authorization decision may be made responsive to valuation of applicants' assets, which are submitted in the resource requests. The system may conduct the asset valuations in real-time. For example, the system may use perceived value/metric associated with assets that are related to the requester's assets to inform the resource allocation decision process, when evaluating the resource requests.

In a further aspect, a method for providing a user interface for requesting resources is disclosed. In particular, the present application describes graphical user interfaces for electronic devices which may facilitate real-time requesting of resources and instantaneous disposition of resource requests. The user interface may be configured to update in real-time in accordance with resource allocation approval data, and enable borrowers to access requested resources in an approved quantity.

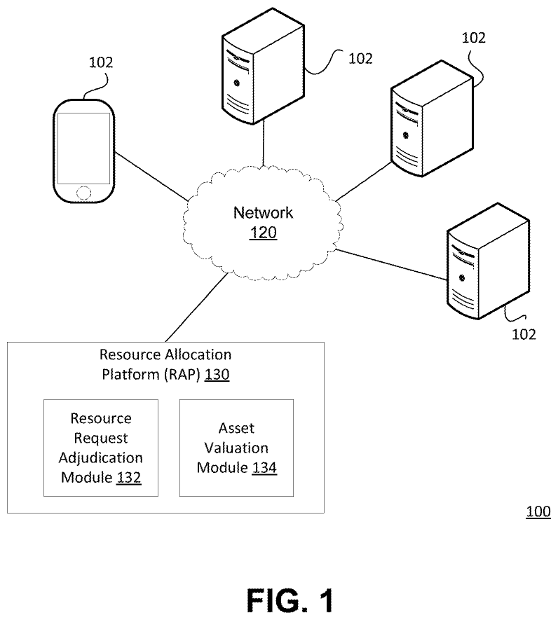

Reference is first made to FIG. 1, which shows an exemplary operating environment in accordance with embodiments of the present disclosure. FIG. 1 illustrates an exemplary system 100 for processing and adjudicating resource requests. More specifically, the system 100 may implement, among others, processes for handling resource request formalities, dynamically obtaining values/metrics associated with assets submitted as part of resource requests, adjudicating resource requests, and granting access to or allocating resources according to the results of the adjudication.

The system 100 includes a plurality of electronic devices 102. Each electronic device 102 is a computer system. An electronic device 102 may be associated with a resource requester, such as a consumer, a business, a system owner/administrator, or other entity desirous of obtaining resources from a lending entity. In some embodiments, an electronic device 102 may be configured to automatically generate a request to obtain resources from a lender when certain predetermined conditions are satisfied. For example, when a computing resource accessible to an electronic device 102 falls below a predefined threshold level, the electronic device 102 may be designed to automatically request for additional resources from one or more lending entities with resource capacity. An electronic device 102 may be associated with a lender, which may be configured to share resources with one or more requesting entities.

In some embodiments, the electronic device 102 may be a portable electronic device. For example, the electronic device 102 may, as illustrated, be a smartphone. The electronic device 102 may be a computing device of another type such as a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments. In some embodiments, the electronic device 102 may include a smart card, chip card, integrated circuit card (ICC), and/or other card having an embedded integrated circuit.

The electronic device 102 is configured to execute software, such as a resource requesting application (not shown). A resource requesting application may, for example, be a web application (e.g. single-page application, or SPA), a mobile application, or a desktop application. In some embodiments, the resource requesting application may be implemented as a component or feature of another application, such as a mobile banking or payment app. The resource requesting application may be an app that can be used to request and apply for access to a certain quantity of desired resources. In some embodiments, the resource requesting application may comprise a Web browser application that is configured to run and display a Web form interface for applicants to use when applying to gain access to desired resources.

The network 120 is a computer network. The network 120 allows computer systems in communication therewith to communicate. For example, as illustrated, the network 120 may allow the electronic devices 102 to communicate with a loan processing platform (RAP) 130.

The resource allocation platform (RAP) 130 is implemented as part of a computer system. The RAP 130 may be implemented by one or more computing devices such as, for example, database servers, computer servers, and the like. For example, the RAP 130 may be implemented by servers which manage resources for a plurality of connected computing systems. As another example, the RAP 130 may be implemented by servers associated with a financial institution (e.g. bank, credit union, etc.) interfacing with devices associated with current and/or prospective customers of the financial institution. The computing devices may be in communication with each other using the network 120. Alternatively, the computing devices may communicate using another network such as, for example, a local-area network (LAN). In some embodiments, the RAP 130 may be implemented by multiple computing devices organized in a tiered arrangement (e.g. middle-tier and back-end computing devices). In some embodiments, the RAP 130 may be provided by a cluster formed of a plurality of interoperating computing devices.

The RAP 130 may, in association with one or more different computer systems, handle various services relating to, among others, resource request processing, assets scoring/valuations, customer accounts data management, assets value/metrics retrieval, control of user interfaces for requesting resources, resource request adjudication, and disbursal of approved quantity of requested resource. FIG. 1 illustrates defined components that may be included as part of a computer system implementing the RAP 130, namely, a resource request adjudication module (RRAM) 132 and an asset valuation module 134. Each of these components may be rendered by independent computer systems, or alternatively, one or more of the components may be implemented by the same computer system. In some cases, one or more of the components may be performed or offered together in the RAP 130.

The RRAM 132 comprises a decision engine that is designed to receive and process input data pertaining to a resource request in order to provide a final disposition of the resource request. That is, the RRAM 132 may provide (e.g. as an output) approval data indicating whether to approve or decline a resource request. In particular, resource request data may be forwarded to the RRAM 132 and used by the RRAM 132 in making a resource allocation approval decision. The RRAM 132 may receive, as input, data from multiple sources, such as resource requesters, lender entities, asset value/metric databases, consumer reporting agencies, credit bureaus or credit rating agencies, etc. The data that the RRAM 132 receives in a resource request adjudication scenario may include, for example, requester information (e.g. number of requesting entities, customer data, etc.), resource lending risk models, assets value/metrics, resource lender requirements, resource allocation options, quantity of resources available for allocation, etc. The RRAM 132 may generate an approval decision for each individual resource request, and specify an approved quantity of the requested resource if the request is approved.

The asset valuation module 134 may generate estimates of perceived values or scores of assets. As used in the present application, the term “asset” refers to a resource or property that is owned, controlled, or can be accessed by an entity (e.g. individual, corporation). A request for resources may indicate one or more assets associated with the requester. The perceived values or scores assigned to these assets can inform the decision of whether to approve or decline a particular resource request. The asset valuation module 134 may be configured to access or receive data, such as resource request data, market values of assets, asset location information, resource consumption rate of assets, etc. relating to one or more assets. Based on asset-related data, the asset valuation module 134 may generate perceived values/scores for those assets that are submitted as part of resource requests. In at least some embodiments, an output of the asset valuation module 134 may be provided as input to the RRAM 132. That is, a perceived value/score of an asset associated with a requester may be relayed as input to the RRAM 132 such that a resource approval decision is made based, at least in part, on the perceived value/score of one or more assets.

In some embodiments, the asset valuation module 134 may not be included as part of a computer system implementing RAP 130. For example, the asset valuation module 134 may be provided on an independent server that is communicably coupled to the computer system administering the RAP 130.

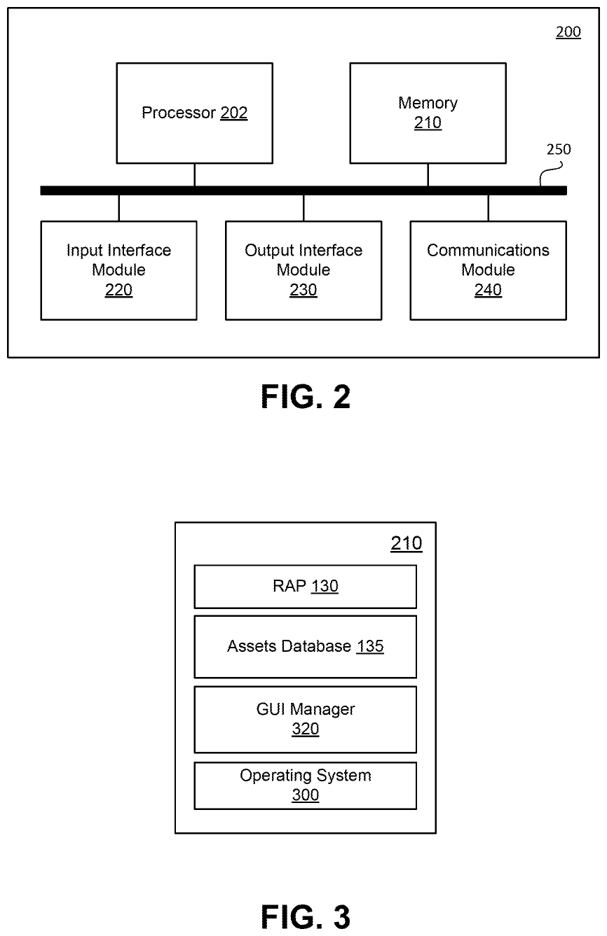

FIG. 2 is a high-level operation diagram of an example computing system 200 that may be configured to implement an RAP 130. The computing system 200 of FIG. 2 includes a variety of modules. For example, as illustrated, the computing system 200 may include a processor 202, a memory 210, an input interface module 220, an output interface module 230, and a communications module 240. As illustrated, the foregoing example modules of the computing system 200 are in communication over a bus 250.

The processor 202 is a hardware processor. Processor 202 may, for example, be one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the electronic device 102.

The input interface module 220 allows the computing system 200 to receive input signals. Input signals may, for example, correspond to input received from a user. The input interface module 220 may serve to interconnect the computing system 200 with one or more input devices. Input signals may be received from input devices by the input interface module 220. Input devices may, for example, include one or more of a touchscreen input, keyboard, trackball or the like. In some embodiments, all or a portion of the input interface module 220 may be integrated with an input device. For example, the input interface module 220 may be integrated with one of the aforementioned example input devices.

The output interface module 230 allows the computing system 200 to provide output signals. Some output signals may, for example allow provision of output to a user. The output interface module 230 may serve to interconnect the computing system 200 with one or more output devices. Output signals may be sent to output devices by output interface module 230. Output devices may include, for example, a display screen such as, for example, a liquid crystal display (LCD), a touchscreen display. Additionally or alternatively, output devices may include devices other than screens such as, for example, a speaker, indicator lamps (such as for, example, light-emitting diodes (LEDs)), and printers. In some embodiments, all or a portion of the output interface module 230 may be integrated with an output device. For example, the output interface module 230 may be integrated with one of the aforementioned example output devices.

The communications module 240 allows the computing system 200 to communicate with other electronic devices and/or various communications networks. For example, the communications module 240 may allow the computing system 200 to send or receive communications signals. Communications signals may be sent or received according to one or more protocols or according to one or more standards. For example, the communications module 240 may allow the computing system 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 240 may allow the computing system 200 to communicate using near-field communication (NFC), via Wi-Fi™, using Bluetooth™ or via some combination of one or more networks or protocols. Contactless payments may be made using NFC. In some embodiments, all or a portion of the communications module 240 may be integrated into a component of the computing system 200. For example, the communications module may be integrated into a communications chipset.

Software comprising instructions is executed by the processor 202 from a computer-readable medium. For example, software may be loaded into random-access memory from persistent storage of memory 210. Additionally or alternatively, instructions may be executed by the processor 202 directly from read-only memory of memory 210.

FIG. 3 depicts a simplified organization of software components stored in memory 210 of the computing system 200. As illustrated, these software components include an operating system 300, RAP 130, an assets database 135, and a graphical user interface manager 320.

The operating system 300 is software. The operating system 300 allows the RAP 130 to access the processor 202, the memory 210, the input interface module 220, the output interface module 230 and the communications module 240. The operating system 300 may be, for example, Apple iOS™, Google™ Android™, Linux™, Microsoft™ Windows™, or the like.

The graphical user interface (GUI) manager 320 manages information that may be displayed on a user device when a user makes a manual request for resources. When a user requests to receive or access certain resources using its device, it is desirable to display information about the request that is specifically tailored for that user. For example, a requester may wish to view, via the user interface, relevant information such as: quantity of a resource that is available to be accessed or used by the requester; types of resources available for the requester; identities of lender entities; options for accessing the requested resources upon approval; fillable forms for inputting request data; history of resource requests and approval decisions; asset data for one or more assets associated with the requester; and comparison data for two or more different borrowing options (e.g. alternative sources of a resource). The GUI manager 320 may generate a user interface which can be displayed on the device of a requester, such that the requester can make a manual resource request, to a lending node and/or a resource request processing entity, using the user interface. In particular, the GUI manager 320 may determine display data that should be rendered for a requesting user's device, at a time requested by a user associated with the device.

The assets database 135 comprises a repository of assets. The assets database 135 may store data associated with the assets. In some embodiments, the assets database 135 may contain information relating to assets that are associated with specific entities (e.g. business, consumer, computer system/network, etc.). For example, the assets database 135 may contain a listing of one or more assets that are owned by customers of an organization (e.g. financial institution). The assets database 135 may be updated manually as entries are added to the database, or updated automatically as data from different sources are used to populate the assets database 135.

The asset valuation module 134 may be connected to and in communication with the assets database 135. In particular, the asset valuation module 134 may access data from the assets database 135 in obtaining estimates of perceived value/scores of various assets.

In some embodiments, the memory 210 may also include a user accounts database containing account data for a plurality of users. The users may, for example, be customers of a business or institution, and the user accounts may maintain information relating to various assets and liabilities of those customers. The user accounts database may alternatively contain information regarding administrators/controllers of one or more computer systems that are associated with resource requesting entities. Such a database may provide relevant current and historical data for a user/requester that can be used by a resource request adjudicating entity in generating resource allocation approval data.

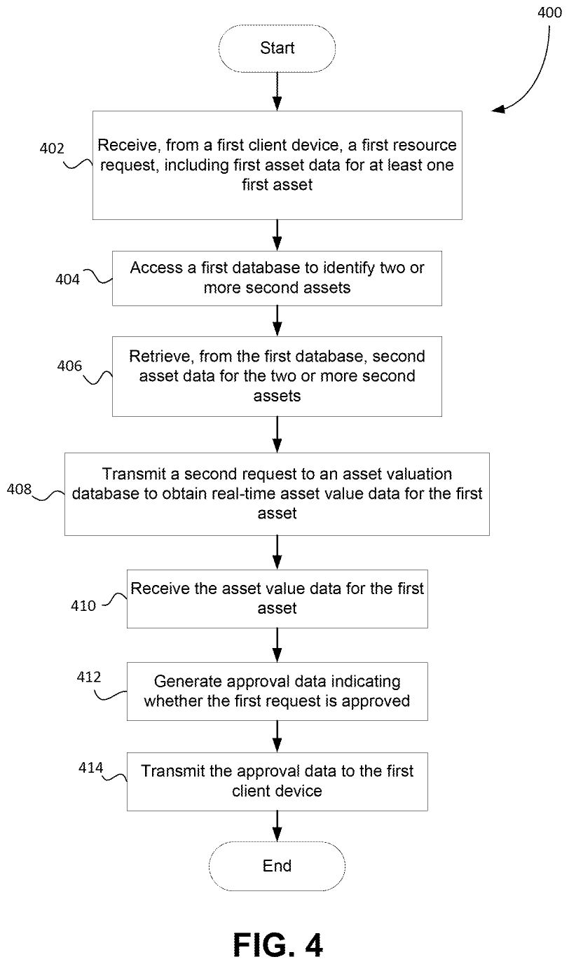

Reference is made to FIG. 4, which shows, in flowchart form, an example method 400 for processing a resource request. The method 400 may be performed by a computing system implementing a platform for managing resource requests (such as RAP 130). The computing system may be communicably coupled to a plurality of client devices corresponding to resource requesting and/or lender entities. The computing system may function as an intermediary between the client devices, enabling lending and borrowing activities. The computing system may be associated with a controlling entity for a resource owner. It will be understood that a lender entity may be a client device that is connected to the computing system implementing a RAP 130, or an organization which employs a RAP 130 to adjudicate resource requests that it receives. A RAP 130 may facilitate resource sharing activities between multiple lending and borrowing client devices, or it may manage the lending decisions of only a single lending entity.

In operation 402, the computing system receives, from a first client device, a first resource request. The first resource request includes, at least, a quantity of a first resource that is requested, an identity of a requesting entity, and first asset data for at least one first asset. In at least some embodiments, the first resource request may be made manually via a user interface on the first client device. The user interface may, for example, present fillable forms that prompt the requester to provide detailed information about the requester, such as personal information (identifier of requester, occupation, etc.), and a quantity of the first resource that is being requested.

In some embodiments, the first resource request may be generated automatically at the first client device. For example, the first client device may generate the first resource request in response to detecting a predefined trigger. One such trigger may be a quantity of resources available to the first client falling below a certain threshold level. That is, if the first client device detects that a quantity of a first resource that is available for its use or consumption is below a threshold, the first client device may automatically determine that a resource request should be made, either directly to another client device that has capacity to share a desired resource or to an RAP 130 which makes resource allocation decisions.

The first asset data may be manually indicated by the requester. The first asset data includes, at least, location information associated with the first asset. For example, if a requester lists one or more assets (e.g. properties) as part of the resource request, the associated first asset data may indicate the locations (e.g. precise or approximate address) of those assets. As another example, if a requesting entity lists a computing system, such as a mobile electronic device, as the first asset in the resource request, a location associated with the computing system may be included in the first asset data. In cases where the location associated with a computing system is not readily available, the location information may first be collected, for example, by using geo-location capabilities of the computing system.

In operation 404, the computing system accesses a first database to identify two or more second assets that are different from the first asset. For example, the computing system may access a database containing data relating to a plurality of assets that are known or accessible to a resource allocation adjudication authority, such as a network resource manager or a banking institution. The selection of the second assets is made based on determining that location information associated with each of the second assets satisfies at least one predetermined condition relating to the location information associated with the first asset. That is, two or more second assets are selected such that the respective location associated with each of said second assets satisfies certain predefined conditions related to the location of the first asset.

In some embodiments, the predetermined condition may be that the second asset is located within a predefined distance of a location of the first asset. For example, given a location for a first asset (e.g. mobile device), the second assets may be selected if their current or recent location is determined to be within a threshold distance from the location of the first asset. The computing system may, for example, filter assets from the first database by relative geographic proximity, allowing for selection of those assets that are located within the threshold distance from the first asset.

In some embodiments, the predetermined condition may be that the second asset is located in a same geographic region as the first asset. For example, if the first asset is located in a certain town, city, district, or other identifiable administrative division or geographic classification, the second assets may be selected such that they are located in the same town, city, etc. The geographic classification associated with the first and second assets may be available in the resource request data and the first database, or the computing system may be configured to obtain said classification information in operation 404.

In operation 406, the computing system retrieves, from the first database, second asset data for the two or more selected second assets. The data retrieved in operation 406 may, for example, include current and historical market values of the second asset, score/metric assigned to the second asset, identity of owner(s) of the second asset, user account data for said owner(s) (e.g. resources previously borrowed by said owner(s)), etc. In at least some embodiments, the computing system may retrieve data from multiple sources, and not only the first database. For example, the computing system may access various market-related indices and automated valuation models to retrieve data pertaining to the second assets. Thus, in some embodiments, the asset data for assets in the first database may be dynamically updated based on real-time changes in market value of said assets.

In operation 408, a second request is transmitted to an asset valuation database (such as asset valuation module 134) to obtain real-time asset value data for the first asset based on the retrieved second asset data. That is, a request to obtain a value/metric for the first asset identified in the initial resource request is transmitted to an asset valuation database. The asset valuation database may be implemented by the computing system proper, or it may be an independent module that is accessible to the computing system.

The asset value data for the first asset that is generated by the asset valuation database may depend on several factors, such as type of asset, type and quantity of resource requested, and client's resource requirement information. By way of illustration, a first asset's value or metric may depend on market value of second assets that are proximate in location to the first asset. For example, an appraisal value for a first property or asset may depend on, resemble, or be influenced by, known market value of properties/assets that are in close relative location with respect to the first property/asset. Assets may be determined to be in close relative location of each other if they are, for example, within a predefined distance from each other, or are located within the same geographically classified region (e.g. in the same neighborhood). This type of asset valuation may be particularly applicable in the context of real estate assets that are appraised using an automated system, such as RAP 130.

As another example, a first computing system, such as a mobile device, may request for additional bandwidth resources. The first computing system may be located proximate to other second computing systems that have capacity to share bandwidth resources. In such a case, it may be desirable for the first computing system to request to share bandwidth with nearby computing systems, rather than, for example, a bandwidth allocation entity implementing an RAP 130 that is located far from the first computing system.

As yet another example, a first computing system may request to receive transmission of data from a data source. The second assets for such a data request scenario may comprise one or more cell sites located proximate to the first computing system (or a first cell site associated with the first computing system). By considering the capacity, availability, relative location, etc. of the cell sites which may be able to transmit data to the first computing system, a “metric” may be assigned to the first computing system, the metric reflecting the desirability of providing data to the first computing system given the status of the cell sites. Another factor which may be considered in gauging the desirability of approving data transmission is whether the region or locale associated with the first asset is well serviced by the cell sites in the area. If there is an insufficient number of cell sites, or if the cell sites are generally at capacity, it may be determined that a data transmission to the first computing system may not be desirable at the relevant time. Alternatively, if an area is not serviced by a suitable number of cell sites, or if those cell sites are generally not available, it may be desirable to prioritize transmission of data to such an area over transmissions to areas having large numbers of communications equipment with capacity.

More generally, the asset “value” or “metric” that is output by the asset valuation database may reflect the desirability, priority, or estimated economic value of the first asset included in the first resource request. As illustrated through the above examples, the “valuation” of the first asset may depend on myriad factors and criteria, as well as the resource request context, which can be built into an asset valuation engine or application programming interface (API).

In operation 410, the computing system receives, from the asset valuation database, the asset value data for the first asset. The asset value data may be forwarded to, for example, a resource allocation adjudication entity, such as RRAM 132 of FIG. 1. That is, the asset value data is passed as input to the adjudication process. In at least some embodiments, the received asset value data indicates a first value of the first asset. The first value may, for example, be an economic value (or an estimate thereof) or a suitable metric representing a desirability of sharing a resource with a requesting entity that submits the first asset in the resource request. In the context of real estate appraisal, the asset value data may, for example, indicate a price per square foot associated with the first asset.

In operation 412, approval data for the first resource request is generated. The approval data indicates whether the first resource request is approved, based on the first resource request data and the received asset value data for the first asset. In some embodiments, the approval data may indicate a quantity of the first resource that is approved to be allocated to the requester. More generally, the approval data may serve as a basis for initiating a process of allocating (or granting access to) an approved quantity of the requested resources for the requester. For example, where the requester is associated with a first resource account, account permissions for the first resource account may be updated based on the approval data. In particular, an authorization for the requester to access additional resources corresponding to an approved resource quantity may be generated and granted to the requester.

In operation 414, the approval data for the first resource request is transmitted to the first client device. The approval data may be suitably formatted for presentation on a user interface associated with the first client device. In particular, the display of a user interface for requesting resources on the first client device may be updated to provide the approval data as a response to submission of a resource request via the user interface. For example, the transmitted approval data may include a field or message for presenting on the user interface, indicating that the resource request has been approved.

In at least some embodiments, the approval data may be provided to the first client device on-demand and in real-time. For example, a user interface of the first client device may be updated with real-time results of the resource allocation adjudication process. The systems and methods of the present disclosure facilitate instantaneous disposition of resource requests that is based on asset valuation data for the requester's assets. The data itself may be collected in real-time and used to inform the resource allocation decision. The approval data, which may indicate the allocation decision as well as the quantity of approved resources, may be presented in real-time on a computing device accessible by the requester. For example, if a resource request is made via a device configured for resource disbursal, such as an automated teller machine (ATM), the device may display a resource allocation decision for the requester immediately after the request is made. As another example, if a requester uses a web browser or mobile app interface to request resources, a display of the approval data may be provided on the interface instantaneously, after the request is received via the interface.

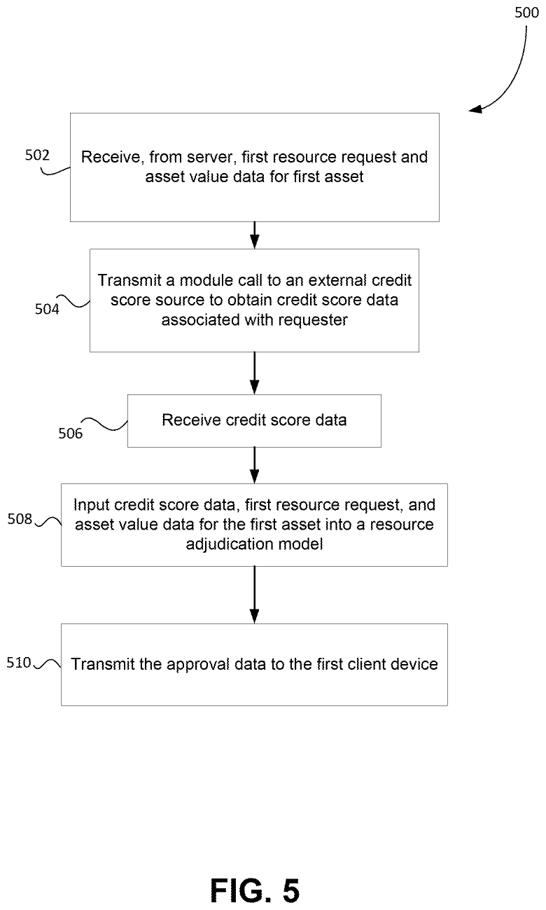

Reference is now made to FIG. 5, which shows an example method 500 for adjudicating a resource request. The method 500 may be performed by a computing system, module, etc. implementing a resource allocation adjudication scheme, such as RRAM 132 of FIG. 1. For example, the method 500 may be performed by a server associated with a resource management entity (e.g. network administrator, banking institution) that includes, or has access to, a module that processes resource request input data and outputs a resource allocation decision.

In operation 502, a decision module receives a first resource request and asset value data for at least one first asset. The first resource request may include, at least, information identifying a requester, a quantity of a first resource being requested, and location information associated with one or more assets associated with the requester. The asset value data comprises data representing actual or estimated value of the first asset submitted by a requester as part of a resource request. As explained above, a “value” or “metric” associated with an asset may inform the decision of whether to approve or reject a resource request. For example, the asset value may be representative of an overall desirability or priority of lending a quantity of resources to a requester. This measure of desirability may be based on, among others, a context of the resource request, the type and quantity of resources requested, and locations of assets associated with the resource request.

By way of example, in some embodiments, the first asset may represent a collateral which offers security to a lender should the requester fail to return a temporarily acquired resource. The first asset may serve as the lender's protection against the borrower's default, and can be used to offset the resource allocation, if approved. The first asset may, for example, be a tangible property, such as property, plant, or equipment. In some embodiments, the first asset may represent a resource that is offered by a requester to a potential lender in exchange for allocation of a requested resource. For example, a requesting entity may indicate, as part of a resource request, a quantity of a first computing resource (e.g. memory) which is offered in exchange for a lender's allocation of a second computing resource (e.g. CPU). The requesting entity may be a computing device, or an administrator thereof, and the resource request may identify a quantity of random or virtual memory that is available to be offered to a lender entity. The offered quantity may serve as an incentive for the lender to share the requested resource with the requester, and have a favourable effect on the request approval decision. In particular, the requester's offer of the first asset may be taken into account during the resource allocation adjudication process.

In operation 504, a module call is transmitted to an external credit score source to obtain credit score data associated with the requester. For example, the decision module may request to receive, from a credit bureau or credit rating agency, credit information associated with the requester. More generally, in operation 504, the decision module may access one or more databases that contain historical data relating to the requester's loan performance, such as borrowing and re-paying or returning the borrowed resource. Such data may serve as a useful tool in predicting the requester's future behavior and, thus, an expected risk of lending to the requester.

In operation 506, the decision module receives credit score data. In operation 508, the credit score data, the first resource request, and the asset value data for the first asset are relayed as input into a resource allocation adjudication model. The resource allocation adjudication model may be implemented by or as part of the decision module. The resource allocation adjudication model may, for example, be an algorithm for assessing desirability of lending resources to a particular requester given the data regarding the requester's creditworthiness, first asset, and other resource request information. The model may incorporate thresholds of risk that the lending entity establishes in relation to resource requests, and use those thresholds in assessing the desirability of approving the resource request. Once the assessment is completed, the model may output an approval decision of whether the resource request is approved or rejected. In some embodiments, the model may be configured to output a partial approval decision; that is, the model may approve sharing a quantity of a requested resource that is less than the specific quantity requested by the requester.

In operation 510, the approval data generated by the decision module is transmitted to the first client device associated with the requester. The approval data may then be presented to the requester via, for example, a user interface of the first client device.

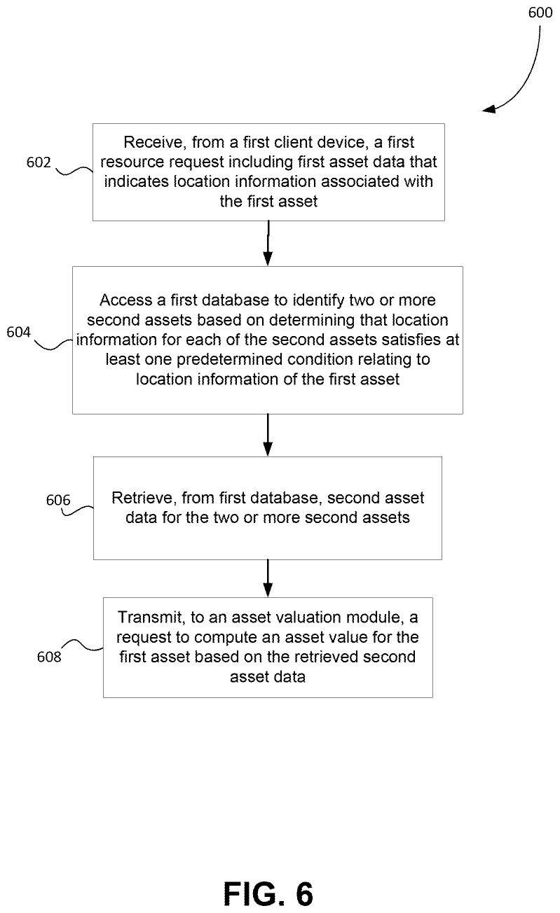

Reference is now made to FIG. 6, which shows, in flowchart form, an example method 600 for obtaining a perceived value/score of an asset associated with a resource requesting entity. The method 600 may be performed by a computing system, module, etc. implementing a resource allocation platform, such as RAP 130. The computing system may execute method 600 when handling resource requests that include asset information provided by the requesters, where the value or metric associated with the requesters' assets may inform the decision of whether to approve or decline the resource requests.

In operation 602, the computing system receives, from a first client device, a first resource request including first asset data. The first client device may be a computing system that is associated with a resource requester. The first asset data that is included in the resource request indicates, at least, location information associated with the first asset. For example, the first asset data may specify a physical address associated with a property belonging to the resource requester. As another example, the first asset data may include an Internet Protocol (IP) address assigned to a device connected to a computer network.

In operation 604, the computing system accesses a first database to identify two or more second assets. The first database may be a database containing information relating to assets having associated values/metrics that are known. In some embodiments, the first database may contain a plurality of assets owned by or associated with the customers of a business or institution. The first database may, for example, indicate estimated values (e.g. market value, mortgage amount, etc.) associated with the assets. The asset data in the first database may specify historical and/or pending resource request information and status for one or more assets. In particular, for each of one or more of the assets of the first database, asset data stored in the first database may include: initial value of asset; amount of resources requested to acquire the asset; time (e.g. date) of acquisition of asset; past appraisal values for the asset; status of resource request (e.g. applied, pending, finalized, etc.); and geographical or virtual location associated with the asset. The data in the first database may be filtered, for example, by resource request status. As another example, the first database may indicate, for one or more assets, metrics of desirability of lending resources based on said assets. For example, the first database may contain information regarding computing devices, cell towers, etc. that are capable of receiving data, as well as measures of desirability of transmitting data to those devices, etc. These measures may be obtained based on various criteria that are resource request context- and type-dependent.

In some embodiments, the first database may contain information from previously completed resource allocation adjudications. That is, for one or more assets, the first database may indicate the valuations of the assets that were determined in previous dispositions of resource allocation requests. The second assets are identified based on determining that location information for each of said second assets satisfies at least one predetermined condition relating to the location information of the first asset.

The computing system then retrieves, from the first database, second asset data for the two or more second assets identified, in operation 606. That is, the computing system may cross-reference data for the identified second assets from the first database. In operation 608, the computing system transmits, to an asset valuation module (such as module 134), a request to compute an asset value for the first asset based on the retrieved second asset data. That is, a request may be transmitted to an independent server that implements an asset valuation module. In some embodiments, an asset valuation module may be integrated as part of the computing system implementing an RAP. In such cases, the processor associated with the computing system may itself perform the computation of the asset value for the first asset, rather than transmitting a request to do so to an entity independent of the computing system.

As an illustrative example, the computing system may be associated with a mortgage lender. The lender may have access to a private database, which acts as the first database, that stores information relating to a plurality of assets. In particular, the private database may contain information pertaining to various assets for which loan requests to the lender were made, in order to acquire the assets. That is, the assets in the database may correspond to loan requesting entities that have submitted requests (e.g. applications) to receive loans from the lender. For example, the database may contain asset information which may be derived from one or more loan requests to the lender at various stages of request processing, i.e. application, post-approval (pending), and finalized.

At each stage of loan request processing, there may be valuable data that can be extracted about a property for which a mortgage is requested. As an example, for mortgage applications that are pending, the computing system may obtain information such as a sale price (or offer price, bid prices, etc.), expected date of closing of sale, and/or location of the property. This information may be used to derive/forecast expected market values of properties with similar characteristics, such as location, size, etc. Such information, obtained by the computing system by virtue of its access of a private database storing transaction data for as-yet incomplete transactions, may not be ascertainable by the general public or those with knowledge only of publicly disclosed information. For finalized loan requests, information such as location, final sale price, loan amount granted, etc. may be obtained by the computing system.

Having access to this private database, the computing system may obtain asset value for an asset by cross-referencing location information (i.e. address) of a property with the private database. More generally, the computing system associated with a lender may make use of datasets that are available from its private databases to obtain asset value for a first asset or asset data for one or more second assets that are identified based on determining that those second assets satisfy certain conditions associated with the location information for the first asset. The computing system may dynamically obtain asset value for the first asset using information that is privately accessible in its proprietary databases. By accessing all available datasets, the computing system associated with the lender may be positioned to conduct an accurate adjudication of loan requests.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computing device comprising:
a processor;
a communications module coupled to the processor;
a computer-readable storage medium coupled to the processor and containing instructions configured to cause the processor to:
receive from a first client device via the communications module a first resource request including a quantity of a first resource that is requested, an identity of a requester, and first asset data for a first asset, the first asset data including location information associated with the first asset;
access a first database to identify two or more second assets different from the first asset based on determining that location information associated with each of the two or more second assets satisfies at least one predetermined condition relating to the location information associated with the first asset;
retrieve, from the first database, second asset data for the two or more second assets;
transmit a second request to an asset valuation database via the communications module, the second request to obtain real-time asset value data for the first asset based on the retrieved second asset data;
receive, from the asset valuation database, the asset value data for the first asset;
generate approval data indicating whether the first resource request is approved, the approval data being generated based on the first resource request and the received asset value data for the first asset; and
transmit the approval data to the first client device.

2. The computing device of claim 1, wherein the at least one predetermined condition comprises the two or more second assets being located within a predetermined distance of a location of the first asset.

3. The computing device of claim 1, wherein the at least one predetermined condition comprises the two or more second assets being located in a same geographic region as the first asset.

4. The computing device of claim 1, wherein the instructions are configured to cause the processor to update account permissions for a first resource account associated with the requester based on the approval data.

5. The computing device of claim 4, wherein updating account permissions for the first resource account comprises generating an authorization for the requester to access additional resources corresponding to an approved resource quantity.

6. The computing device of claim 1, wherein asset data for assets in the first database is dynamically updated based on real-time changes in market value of said assets.

7. The computing device of claim 1, wherein the approval data indicates a quantity of the first resource that is approved.

8. The computing device of claim 1, wherein the received asset value data indicates a first value of the first asset.

9. The computing device of claim 1, wherein the received asset value data indicates a price per square foot associated with the first asset.

10. The computing device of claim 1, wherein the instructions are further configured to cause the processor to receive credit score data for the requester from at least one external credit source, wherein the approval data is generated based on the received credit score data.

11. A method comprising:
receiving from a first client device a first resource request including a quantity of a first resource that is requested, an identity of a requester, and first asset data for a first asset, the first asset data including location information associated with the first asset;
accessing a first database to identify two or more second assets different from the first asset based on determining that location information associated with each of the two or more second assets satisfies at least one predetermined condition relating to the location information associated with the first asset;
retrieving, from the first database, second asset data for the two or more second assets;
transmitting a second request to an asset valuation database, the second request to obtain real-time asset value data for the first asset based on the retrieved second asset data;
receiving, from the asset valuation database, the asset value data for the first asset;
generating approval data indicating whether the first resource request is approved, the approval data being generated based on the first resource request and the received asset value data for the first asset; and
transmitting the approval data to the first client device.

12. The method of claim 11, wherein the at least one predetermined condition comprises the two or more second assets being located within a predetermined distance of a location of the first asset.

13. The method of claim 11, wherein the at least one predetermined condition comprises the two or more second assets being located in a same geographic region as the first asset.

14. The method of claim 11, further comprising updating account permissions for a first resource account associated with the requester based on the approval data.

15. The method of claim 14, wherein updating the account permissions for the first resource account comprises generating an authorization for the requester to access additional resources corresponding to an approved resource quantity.

16. The method of claim 11, wherein asset data for assets in the first database is dynamically updated based on real-time changes in market value of said assets.

17. The method of claim 11, wherein the approval data indicates a quantity of the first resource that is approved.

18. The method of claim 11, wherein the received asset value data indicates a first value of the first asset.

19. The method of claim 11, wherein the received asset value data indicates a price per square foot associated with the first asset.

20. The method of claim 11, further comprising receiving credit score data for the requester from at least one external credit source, wherein the approval data is generated based on the received credit score data.
